(19) United States
(12) Patent Application Publication
(10) Pub. No.: US 2009/0119505 A1
(43) Pub. Date: May 7, 2009

(54) Transaction method and verification method

(75) Inventors: Scott MacDonald Ward, Aerdenhout (NL); Teunis Tel, Groningen (NL)

Correspondence Address: PAUL, HASTINGS, JANOFSKY & WALKER LLP, 875 15th Street, NW, Washington, DC, 20005, US

(73) Assignee: DTS Ltd., Lavitts Quay, Cork (IE)

(21) Appl. No.: 11/913,748

(22) PCT Filed: May 10, 2005
(86) PCT No.: PCT/NL05/00353

§ 371 Date: May 19, 2008

(51) Int. Cl. G06F 1/00

(52) U.S. Cl. 713/156

(57) ABSTRACT

In a method for performing an electronic transaction a first transaction part generates a digital signature and an encrypted digital signature. The second transaction party receives both signatures. The second party is enabled to verify the digital signature, but cannot verify or (re)generate the encrypted digital signature. A trusted third party is enabled to verify the encrypted digital signature if the digital signature is also provided, since the trusted third party cannot (re)generate the digital signature. Thus, no other party than the first transaction party can (re)generate both the digital signature and the encrypted digital signature. Therefore, no other party presenting himself as the first transaction party can be verified as being the first transaction party.

The present invention relates to a transaction method and a verification method for verifying a transaction party.

At present, numerous transactions are being handled by electronic means in digital format. Digital networks have evolved which enable parties of different kind across the world to communicate with each other and to exchange data and information to reach desired transactions.

In transactions, in particular in transactions involving private network access, contractual or financial commitments, settlements and/or payments, each party involved in such a transaction wants to verify any other party, or at least, to be able to track any other party, if after completion of the transaction a problem arises. For such verification purposes, it is known to use personal identifiers, such as passwords, Personal Identification Numbers (PIN), and the like, which are only known to a specific user. However, using personal identifiers over public networks like the Internet, there is a possibility that the personal identifier becomes known to another person, enabling this other person to execute transactions or gain access to digital data presenting himself as somebody else. If a problem arises after completion of the transaction, it is not possible to track the real transaction partner, as its personal identifier may have been used by a malicious user of the public network.

For a more secure transaction, it has been proposed in European Patent Application No. 1 219 088 to use a trusted third party transaction server comprising profiles of the transaction parties. The transaction server verifies the identity of the transaction parties by using authentication data comprising a table of random data for verifying a digital signature. The digital signature is generated from a random token using a token reader. The table of random data corresponds to data collected from said random token. Thus, a digital signature originating from the random token and being different for every subsequent transaction is virtually impossible to forge and therefore uniquely identifies the transaction party by the random token used by the transaction party.

Wo 2004 111752 discloses a method for performing an electronic transaction. The method provides an electronic device with authentication data and authentication software preferably stored in a secure storage location or other location inaccessible to the user or the operating system of the device. When an authenticating digital signature is requested from a first transaction party associated with the electronic device by a second transaction party, the authentication software is activated to generate said digital signature from the authentication data stored in the secure storage location using transaction specific data, thereby generating a transaction specific digital signature. Nest, the digital signature is provided to the second transaction party.

The second transaction party may be storing the authentication data together with identification information of the first transaction party, e.g. because the second transaction party originally provided the authentication data to the first transaction party. Using the transaction specific data, the second transaction party may, like the first transaction party, generate the transaction specific digital signature. A comparison of the received and the generated digital signature enables the second transaction party to verify the identity of the first transaction party.

A consequence of the above-described method of providing a transaction specific digital signature is the fact that the second transaction party holds all data to generate the transaction specific digital signature. Therefore, the second transaction party is enabled to generate a digital signature of the first transaction party, thus enabling fraudulent use. The first transaction party may use this consequence to suggest that the second party used its capability to commit fraud after the transaction, thereby attempting to cause uncertainty whether the first transaction party performed the transaction. Further, any other party may obtain all data illegally from the second transaction party and perform transactions while presenting himself as the first transaction party.

It is an object of the present invention to provide a transaction method and authentication method wherein a transaction party may be verified beyond reasonable doubt.

To reach the above object the present invention provides a method for enabling authentication of a first transaction party of an electronic transaction with a second transaction party, the method comprising installing an electronic device of said first transaction party, the method comprising:
providing authentication data in a first memory section of said electronic device such that the authentication data are inaccessible to a user of said electronic device;
the second transaction party providing public identification data in a second memory section of said electronic device;
generating a secret identification code SIC in the electronic device of the first transaction party;
storing the SIC in a third memory section of said electronic device such that the SIC is inaccessible to a user of said electronic device;
the second transaction party providing the authentication software to said electronic device, the authentication data and the SIC being accessible to said authentication software;
a generating a SIC-certificate by encrypting the SIC in the electronic device of the first transaction party;
generating a session encryption key from the authentication data using session specific data in the electronic device of the first transaction party;
providing the SIC-certificate and at least one of the session encryption key and the session specific data to the second transaction party;
the second transaction party storing the public identification data, the SIC-certificate and said at least one of the session encryption key and the session specific data together with the authentication data;
encrypting the SIC using the session encryption key thereby generating an encrypted SIC in the electronic device of the first transaction party;
providing at least the SIC-certificate and the encrypted SIC to a trusted third party.

The present invention further provides a method for performing an electronic transaction between a first transaction party and a second transaction party, both transaction parties being enabled in accordance with the above method for enabling authentication of one of said transaction parties, the method comprising:
activating the authentication software to generate a digital signature from the authentication data;
encrypting the digital signature using the SIC as an encryption key thereby generating an encrypted digital signature;
providing the digital signature and the encrypted digital signature to the second transaction party.

The present invention further provides a method for verifying a first transaction party having performed an electronic transaction in accordance with the above transaction method, the method comprising:
the second transaction party providing the SIC-certificate, the digital signature and the encrypted digital signature, received during the electronic transaction, to the trusted third party; and
the trusted third party looking up the SIC corresponding to the SIC-certificate and comparing the digital signature and the encrypted digital signature using said SIC.

The present invention improves the method disclosed in WO 2004 111752. In the methods according to the present invention only the first transaction party holds all data needed to generate the digital signature and the encrypted digital signature.

To generate the encrypted digital signature, the digital signature and the secret identification code (SIC) are used. To generate the digital signature the authentication data and the transaction specific data are used. The authentication data, the SIC-certificate and the transaction specific data may be known to the second transaction party. The second transaction party is thus enabled to verify the digital signature. The secret identification code (SIC) however is only known to the first transaction party and the trusted third party, preventing the second transaction party to generate the encrypted digital signature. The trusted third party is not enabled to generate the digital signature because it does not have the transaction specific data or the authentication data.

If the first transaction party is to be verified, possibly in a transaction or when a dispute arises after a transaction, the second transaction party provides the SIC-certificate, the digital signature, which it already may have validated using the authentication data, and the encrypted digital signature, which it received in the transaction, to the trusted third party. The trusted third party, which has the SIC, may encrypt the digital signature and compare the result with the encrypted digital signature or, similarly, it may decrypt the encrypted digital signature and compare the result with the digital signature. Either way, the trusted third party may determine whether the digital signature is encrypted using the secure identification code SIC of the first transaction party.

In an embodiment, the SIC is divided in an encrypt-SIC and a decrypt-SIC forming a pair like a private and a public key as known in the art. The encrypt-SIC is then used to encrypt the digital signature. Only the first transaction party has the encrypt-SIC. The corresponding decrypt-SIC for decrypting the encrypted digital signature is provided to the trusted third party like the SIC in the above described embodiment of the present invention. Thus, in this embodiment, a part of the data needed to generate the encrypted transaction specific digital signature is only available to the first transaction party. No combination of parties is then enabled to falsely generate the encrypted digital signature.

Below, the present invention is elucidated with reference to the appended drawings, wherein

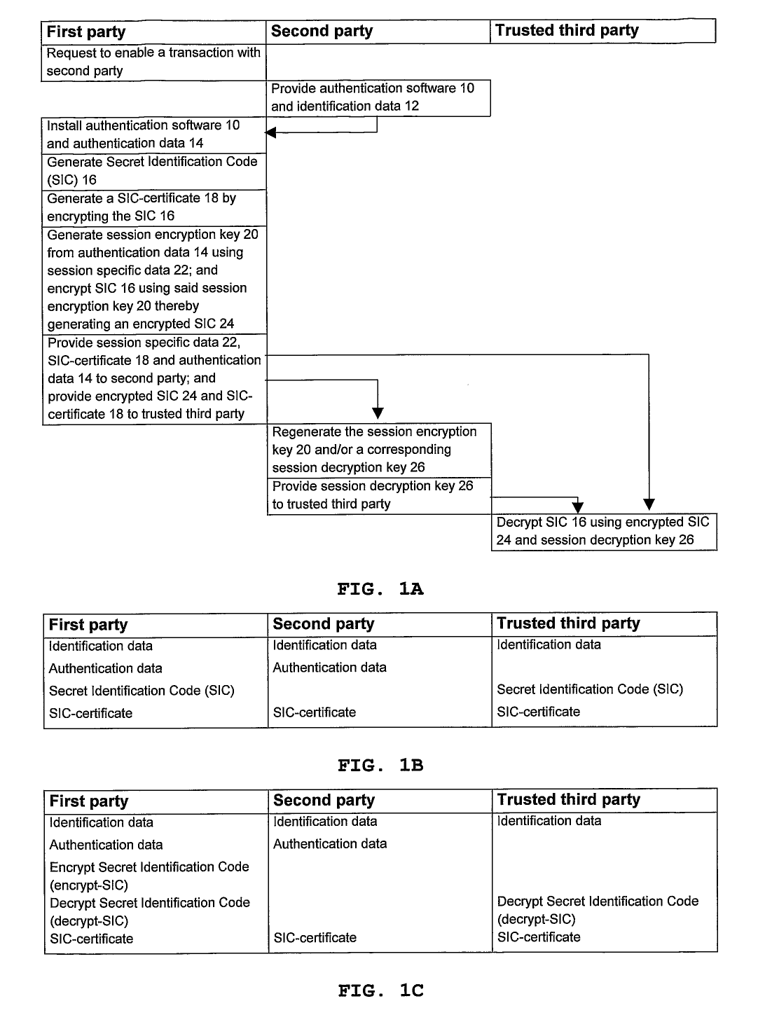

FIG. 1A illustrates an installation method for enabling the authentication method according to the present invention;

FIG. 1B illustrates the data available to each party after the installation method of FIG. 1A;

FIG. 1C illustrates the data available to each party after performing an embodiment of the installation method according to the present invention;

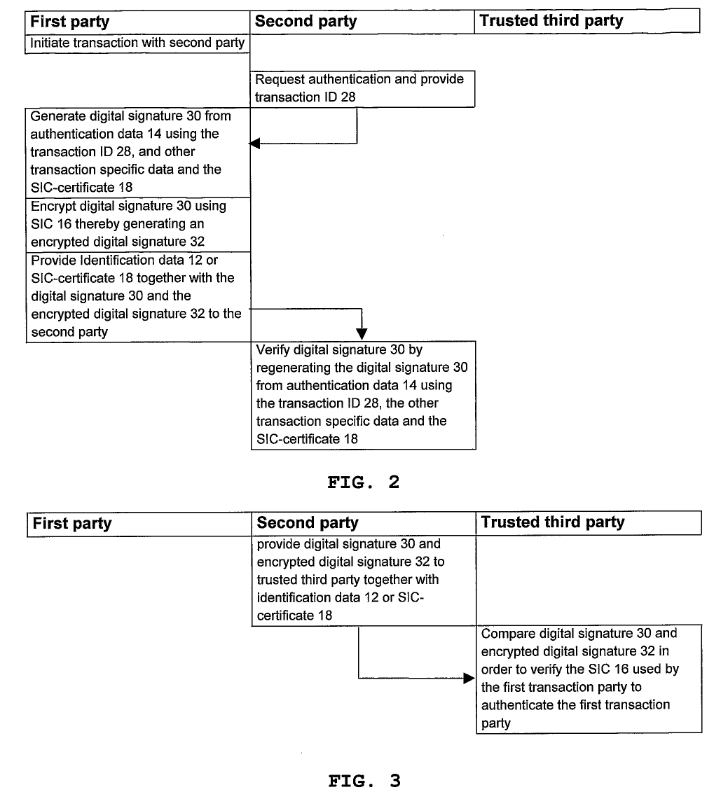

FIG. 2 illustrates a transaction method in accordance with the present invention; and

FIG. 3 illustrates an authentication method according to the present invention.

FIG. 1A shows a scheme of actions performed by each party (each column represents the actions of one party). The row order represents the order of the actions.

Three parties take part in the installation method according to the present invention. A first transaction party and a second transaction party as shown in the left-hand column and the middle column, respectively, intend to perform an electronic transaction. The second transaction party may wish to establish the identity of the first transaction party e.g. because of a payment to be made by the first transaction party. A trusted third party is passively taking part in the installation method. As is described hereinafter, the trusted third party only receives certain data and stores said data.

In a first step 100 of the method the first transaction party contacts the second transaction party requesting to become enabled to perform transactions with the second transaction party. In response, in step 104, the second transaction party provides authentication software 10 and identification data 12 to the first transaction party. The identification data 12 comprises a unique combination of characters or the like to enable to identify the first transaction party later from the received identification data 12. The identification data 12 may of course as well be used later in the method for any further purpose, e.g. encryption of data.

After receipt of the authentication software 10 and the identification data 12, the first transaction party installs the authentication software 10 on its electronic device in step 106. During installation of the authentication software 10, a secure memory section is created or accessed such that the user of the device cannot obtain or alter the data stored in said secure memory section. Only the authentication software 10 may access the secure memory section to obtain data therefrom. Such a method and system is known from WO 2004 111752.

In a secure memory section of the electronic device, authentication data 14 is stored. The authentication data 14 may be randomly generated by the first transaction party or may be derived from the identification data 12, for example. In another embodiment, the second party may provide the authentication data 14 together with the identification data 12. If the authentication data 14 is not provided by the second transaction party or is not unambiguously derivable from the identification data 12, the first transaction party provides the authentication data 14 to the second transaction party e.g. in step 112 to be explained below.

In step 106, the first transaction party generates a secret identification code (SIC) 16, possibly initiated by the authentication software 10. The SIC 16 is generated such that the second transaction party cannot obtain or derive the SIC 16 from any of the data the second transaction party has provided or provides to and/or has received or receives from the first transaction party.

Next, in step 108, the first transaction party encrypts the SIC 16 using a predetermined algorithm, thereby generating a SIC-certificate 18. The algorithm is selected such that it is not possible to derive the original SIC 16 from the SIC-certificate 18.

In step 110, the first transaction party generates a session encryption key 20. The session encryption key 20 is generated using the authentication data 14 and session specific data 22. For example, the session specific data 22 may be a session number, a session date, a random number or any other number. Any combination of numbers or characters is as well suitable. A combination of the authentication data 14, identifying the first transaction party, and the session specific data 22, results in a session specific and first transaction party specific encryption key 20. For example, the authentication data 14 is a table of characters and the session specific data 22 are used to select a number of characters from the table, thereby generating a string of characters.

The session encryption key is then employed to encrypt the SIC 16, thereby generating an encrypted SIC 24.

After generating the above mentioned authentication data 14, the SIC 16, the SIC-certificate 18, the session encryption key 20 and the encrypted SIC 24, the first transaction party provides the following data to the second party and the trusted third party in step 112. The second transaction party is provided with the session specific data 22, the authentication data 14 (if necessary as mentioned above), and the SIC-certificate 18. The trusted third party is provided with the SIC-certificate 18 and the encrypted SIC 24. The trusted third party may receive the identification data 12 as well but this is not required.

In step 114 the second transaction party uses the session specific data 22 and the authentication data 14 to regenerate the session encryption key 20 and/or a corresponding session decryption key 26.

The session decryption key 26 is provided to the trusted third party in step 116.

The trusted third party has received from the first transaction party the SIC-certificate 18 and the encrypted SIC 24, and has received from the second transaction party the session decryption key 26. In step 118 the trusted third party uses the session decryption key to decrypt the encrypted SIC to obtain the SIC 16. Thus, the trusted third party may obtain the SIC and the SIC-certificate.

In FIG. 1B it is illustrated which data is available to each party after the installation as described above in relation to FIG. 1A. The first transaction party, shown in the left-hand column, has available the identification data 12, the authentication data 14, the SIC 16 and the SIC-certificate 18. As is described hereinafter, the authentication data 14 and the SIC 16 are necessary for generating a digital signature and for generating an encrypted digital signature to perform an electronic transaction.

The second transaction party has the identification data 12, the authentication data 14 and the SIC-certificate 18 available. The second transaction party does not have access to the SIC 16 and therefore the second transaction party cannot generate a valid encrypted digital signature.

The trusted third party may have access to the identification data 12, which may be publicly available, but has at least access to the SIC 16 and the SIC-certificate 18. Since the trusted third party does not have access to the authorization data 14, the trusted third party cannot generate a valid (encrypted) digital signature.

FIG. 1C illustrates an installation result of a further embodiment of the installation method according to the present invention, wherein the SIC 16 is divided in an encrypt-SIC 16A and a decrypt-SIC 16B pair. The decrypt-SIC 16B is suitable for decrypting data encrypted using the encrypt-SIC 16A. However, it is not possible to derive the encrypt-SIC 16A from the decrypt-SIC 16B.

During installation in accordance with the method illustrated in FIG. 1A, the SIC 16 is generated in step 106. In the further embodiment, the SIC 16 may be generated as an encryption-decryption pair encrypt-SIC 16A and decrypt-SIC 16B in step 106. Thereafter, only the decrypt-SIC 16B is encrypted to generate an encrypted decrypt-SIC 24B in accordance with step 110 of FIG. 1A. The encrypted decrypt-SIC 24B is provided to the trusted third party in accordance with step 112 of FIG. 1A. The trusted third party thus obtains the decrypt-SIC 16B instead of the SIC 16 as shown in FIG. 1A.

As a result, and as can be seen in FIG. 1C, the encrypt-SIC 16A is only available to the first transaction party. Therefore, no party or combination of second and third parties is enabled to generate a valid encrypted digital signature.

FIG. 2 illustrates a transaction method according to the present invention. The first transaction party is presumed to initiate the transaction in step 200. However, the second transaction party may as well initiate the transaction. After initializing the transaction, a number of actions may be performed by any of the transaction parties. At some point of the transaction, e.g. when the second transaction party accepts the requested transaction, the second transaction party requests the first transaction party to provide an identification and provides a transaction identification number 28 to the first transaction party (step 202).

In response, the first transaction party starts the authentication software as provided in the installation method shown in FIG. 1A. The authentication software is started to generate a digital signature 30 from the authentication data 14 as indicated as step 204. To generate a digital signature 30 from the authorization data 14, additional data is needed, e.g. the transaction identification number 28, a PIN or biometric template and the SIC-certificate 18, thereby tying the digital signature 30 to the transaction and to the first transaction party and/or to a specific authorized user. However, other data may as well be used.

In step 206, the generated digital signature 30 is encrypted using the SIC 16 or the SIC-encrypt 16A as an encryption key. Both the digital signature 30 and the encrypted digital signature 32 are provided to the second transaction party in step 208. In step 210, thereafter, the second transaction party may regenerate the digital signature 30 as the second party has all data available needed to do so (see FIG. 1B or FIG. 1C). Based on a comparison of the received digital signature 30 and the regenerated digital signature 30 the second transaction party may authenticate the first transaction party, the authorized user and/or the integrity of the transaction data.

The second transaction party cannot regenerate the encrypted digital signature 32, because the second transaction party does not have the SIC 16 or the encrypt-SIC 16A available. In any case, the second transaction party will store the data relating to the authentication and the transaction, inter alia including the received digital signature 30, the received encrypted digital signature 32, the transaction identification number 28, the SIC-certificate 18, the authorization data 14 and the identification data 12 to be used in case of a dispute. Thereafter, the transaction may be completed and a connection with the first transaction party may be ended.

FIG. 3 illustrates a verification method according to the present invention. The verification may be performed during the transaction or it may only be performed when a dispute arises after completion of the transaction, for example if the first transaction party claims not to have performed the transaction.

To verify the first transaction party, the second transaction party gathers data such as the received digital signature 30, the received encrypted digital signature 32 and the identification data 12 and/or the SIC-certificate 18. The data is provided to the trusted third party in a first step 300.

After receipt of the data, in step 302, the trusted third party verifies the first transaction party using the identification data 12 or the SIC-certificate 18 and gathers the data previously stored after the installation method as illustrated in FIG. 1A. Since the trusted third party has the digital signature 30 and the SIC 16, the trusted third party may regenerate the encrypted digital signature 32 and compare it with the received encrypted digital signature 32, thereby practically comparing the SIC 16 stored at the trusted third party and the SIC 16 used by the first transaction party for encrypting the digital signature 30.

Likewise, the trusted third party may generate a decryption key corresponding the SIC 16 as an encryption key and decrypt the received encrypted digital signature 32 to obtain the digital signature 30. Then, the obtained digital signature 30 may be compared with the received digital signature 30. If the SIC 16 is divided in an encrypt-SIC 16A and a decrypt-SIC 16B as suggested in relation to FIG. 1C, the trusted third party can of course only perform a decryption of the received encrypted digital signature 32 and verify the now decrypted digital signature 32 by comparison with the obtained digital signature 30.

From the above the person skilled in the art will readily understand how it is achieved that a session-specific and transaction-party-specific digital signature and encrypted digital signature may be generated such that only said first transaction party is enabled to generate said digital signature and encrypted digital signature. Therefore, afterwards or during the transaction, the first transaction may be identified beyond reasonable doubt. The method is described above in the light of the disclosures of WO 2004 111752 and is particularly suitable to be combined with the methods and systems described therein. However, the method according to the present invention may as well be used in combination with other transaction methods without departing from the scope of the invention as will be understood by the person skilled in the art.

1. Method for enabling verification and authentication of a first transaction party of an electronic transaction with a second transaction party, the method comprising installing an electronic device of said first transaction party, the method comprising:
a providing authentication data in a first memory section of said electronic device such that the authentication data are inaccessible to a user of said electronic device;
the second transaction party providing public identification data in a second memory section of said electronic device;
generating a secret identification code SIC in the electronic device of the first transaction party;
storing the SIC in a third memory section of said electronic device such that the SIC is inaccessible to a user of said electronic device;
the second transaction party providing the authentication software to said electronic device, the authentication data and the SIC being accessible to said authentication software;
generating a SIC-certificate by encrypting the SIC in the electronic device of the first transaction party;
generating a session encryption key from the authentication data using session specific data in the electronic device of the first transaction party;
providing the SIC-certificate and at least one of the session encryption key and the session specific data to the second transaction party;
the second transaction party storing the public identification data, the SIC-certificate and said at least one of the session encryption key and the session specific data together with the authentication data;
encrypting the SIC using the session encryption key thereby generating an encrypted SIC in the electronic device of the first transaction party;
providing at least the SIC-certificate and the encrypted SIC to a trusted third party.

2. Method according to claim 1, wherein providing the authentication data (14) in a memory of said electronic device comprises generating the authentication data (14) and storing the authentication data in a secure memory location, inaccessible to the user, the method further comprising providing the authentication data (14) to the second transaction party.

3. Method according to claim 1, wherein the method further comprises:
the second transaction party regenerating the session encryption key (20), if the session specific data (22) were provided;
generating a session decryption key (26) corresponding to the session encryption key (20) and providing the session decryption key (26) to the trusted third party;
the trusted third party decrypting the encrypted SIC (24), thereby obtaining the SIC (16);
the trusted third party storing the SIC (16) together with the SIC-certificate (18).

4. Method according to claim 1, wherein the SIC (16) comprises an encrypt-SIC (16A) and a corresponding decrypt-SIC (16B), the decrypt-SIC (16B) being encrypted using the session encryption key (20) and being provided to the trusted third party together with the SIC-certificate (18).

5. Method for performing an electronic transaction between a first transaction party and a second transaction party, both transaction parties being enabled in accordance with the method according to claim 1, the method comprising:
activating the authentication software (10) to generate a digital signature (30) from the authentication data (14);
encrypting the digital signature (30) using the SIC (16) as an encryption key thereby generating an encrypted digital signature (32);
providing the digital signature (30) and the encrypted digital signature (32) to the second transaction party.

6. Method for performing an electronic transaction between a first transaction party and a second transaction party, both transaction parties being enabled in accordance with the method according to claim 4, the method comprising:
activating the authentication software (10) to generate a digital signature (30) from the authentication data (14);
a encrypting the digital signature (30) using the encrypt-SIC (16A) as an encryption key thereby generating an encrypted digital signature (32);
providing the digital signature (30) and the encrypted digital signature (32) to the second transaction party.

7. Method for verifying a first transaction party having performed an electronic transaction in accordance with the method according to claim 5, the method comprising:
the second transaction party providing the SIC-certificate (18), the digital signature (30) and the encrypted digital signature (32), received during the electronic transaction, to the trusted third party; and
the trusted third party looking up the SIC (16) corresponding to the SIC-certificate (18) and comparing the digital signature (30) and the encrypted digital signature (32) using said SIC (16).

8. Method for verifying a first transaction party having performed an electronic transaction in accordance with the method according to claim 6, the method comprising:
the second transaction party providing the SIC-certificate (18), the digital signature (30) and the encrypted digital signature (32), received during the electronic transaction, to the trusted third party; and
the trusted third party looking up the decrypt-SIC (16B) corresponding to the SIC-certificate (18) and comparing the digital signature (30) and the encrypted digital signature (32) using said decrypt-SIC (16B).

9. Method according to claim 7, the method comprising:
the second transaction party regenerating the session encryption key (20), if the session specific data (22) were provided;
generating a session decryption key (26) corresponding to the session encryption key (20) and providing the session decryption key (26) to the trusted third party;
the trusted third party decrypting the provided one of the encrypted SIC (24) and the encrypted decrypt-SIC (24B), thereby obtaining one of the SIC (16) and the decrypt-SIC (16B).
